(19) United States
(12) Patent Application Publication
(10) Pub. No.: US 2026/0188915 A1
(43) Pub. Date: Jul. 2, 2026

(54) ELECTRONIC DEVICE COMPRISING ANTENNA AND CONTROL METHOD THEREOF

(71) Applicant: Samsung Electronics Co., Ltd., Suwon-si (KR)

(72) Inventors: Hyungpil KUM, Suwon-si (KR); Kihoon KANG, Suwon-si (KR); Donghwan SEO, Suwon-si (KR); Hyeonchang SON, Suwon-si (KR); Jinbae LEE, Suwon-si (KR); Kyeongmun JO, Suwon-si (KR)

(21) Appl. No.: 19/552,379

(22) Filed: Feb. 27, 2026

Related U.S. Application Data
(63) Continuation of application No. PCT/KR2024/018421, filed on Nov. 20, 2024.

(30) Foreign Application Priority Data
Nov. 24, 2023 (KR) 10-2023-0165511
Dec. 7, 2023 (KR) 10-2023-0176881

(51) Int. Cl. H01Q 21/28; H01Q 1/24; H04B 17/318; H04L 5/14; H04W 52/04

(52) U.S. Cl. CPC H01Q 21/28; H01Q 1/241; H04B 17/318; H04L 5/14; H04W 52/04

(57) ABSTRACT

An electronic device is provided. The electronic device includes at least one processor communicatively coupled to a satellite communication circuit, a first wireless communication circuit, and a second wireless communication circuit and including a processing circuit, and memory communicatively coupled to the at least one processor, the memory storing instructions that, when executed by the at least one processor individually or collectively, cause the electronic device to identify activation of satellite communication using the satellite communication circuit during cellular communication using the second wireless communication circuit and perform, based on the identification of the activation of the satellite communication, the cellular communication using one of the first wireless communication circuit and the second wireless communication circuit based on a reception strength of the satellite communication and a threshold transmission power associated with the first wireless communication circuit.

### CROSS-REFERENCE TO RELATED APPLICATION(S)

This application is a continuation application, claiming priority under 35 U.S.C. § 365(c), of an International application No. PCT/KR2024/018421, filed on Nov. 20, 2024, which is based on and claims the benefit of a Korean patent application number 10-2023-0165511, filed on Nov. 24, 2023, in the Ministry of Intellectual Property (MOIP), and of a Korean patent application number 10-2023-0176881, filed on Dec. 7, 2023, in the Ministry of Intellectual Property (MOIP), the disclosure of each of which is incorporated by reference herein in its entirety.

### BACKGROUND

### 1. Field

The disclosure relates to an electronic device including an antenna and a method of controlling the same.

### 2. Description of Related Art

Electronic devices such as smartphones and tablet personal computers (PCs) may transmit and receive data to and from external devices through wireless communication using antennas. The electronic device may perform various functions such as voice calls, video calls, message transmission, or Internet searches using wireless communication data. The communication performance of the antenna mounted on the electronic device may vary depending on various factors. For example, when a metal-based component or another antenna is disposed in the vicinity of the antenna, the communication performance of the existing antenna may be affected by the component or the other antenna.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including an antenna and a method of controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes a first antenna, a second antenna, a third antenna spaced relatively farther apart from the first antenna than the second antenna, a satellite communication circuit communicatively coupled to the first antenna and configured to transmit and receive a satellite signal, a first wireless communication circuit communicatively coupled to the second antenna and configured to transmit and receive a signal associated with cellular communication, a second wireless communication circuit communicatively coupled to the third antenna and configured to transmit and receive a signal associated with cellular communication, at least one processor communicatively coupled to the satellite communication circuit, the first wireless communication circuit, and the second wireless communication circuit and including a processing circuit, and memory communicatively coupled to the at least one processor, and the memory storing instructions that, when executed by the at least one processor individually or collectively, cause the electronic device to identify activation of satellite communication using the satellite communication circuit during cellular communication using the second wireless communication circuit, and perform, based on the identification of the activation of the satellite communication, the cellular communication using one of the first wireless communication circuit and the second wireless communication circuit based on a reception strength of the satellite communication and a threshold transmission power associated with the first wireless communication circuit.

In accordance with another aspect of the disclosure, a method of controlling an electronic device is provided. The method includes identifying activation of satellite communication using a satellite communication circuit of the electronic device during cellular communication using a second wireless communication circuit and performing, based on the identifying of the activation of the satellite communication, the cellular communication using one of a first wireless communication circuit and the second wireless communication circuit based on a reception strength of the satellite communication and a threshold transmission power associated with the first wireless communication circuit.

In accordance with another aspect of the disclosure, one or more non-transitory computer-readable storage media storing one or more computer programs including computer-executable instructions that, when executed by one or more processors individually or collectively, cause the processor to identify activation of satellite communication using a satellite communication circuit of the electronic device during cellular communication using a second wireless communication circuit and perform, based on the identifying of the activation of the satellite communication, the cellular communication using one of a first wireless communication circuit and the second wireless communication circuit based on a reception strength of the satellite communication and a threshold transmission power associated with the first wireless communication circuit.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a system including an electronic device, a base station, and a satellite according to an embodiment of the disclosure;

FIG. 1B is a block diagram illustrating a configuration of an electronic device according to an embodiment of the disclosure;

FIG. 2 illustrates a base station transmitting and receiving signals to and from an upper or lower communication circuit of an electronic device according to an embodiment of the disclosure;

FIG. 3 illustrates a configuration of a wireless communication circuit according to an embodiment of the disclosure;

FIG. 4 illustrates positions of antennas included in an electronic device according to an embodiment of the disclosure;

FIG. 5 illustrates a configuration of a shared antenna included in an electronic device according to an embodiment of the disclosure;

FIG. 6 illustrates signals received by antennas according to an embodiment of the disclosure;

FIG. 7A illustrates an equation and a reference table for calculating backoff values by an electronic device according to an embodiment of the disclosure;

FIG. 7B illustrates backoff values calculated according to an embodiment of the disclosure;

FIG. 8 is a flowchart showing operations of an electronic device according to an embodiment of the disclosure; and

FIG. 9 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

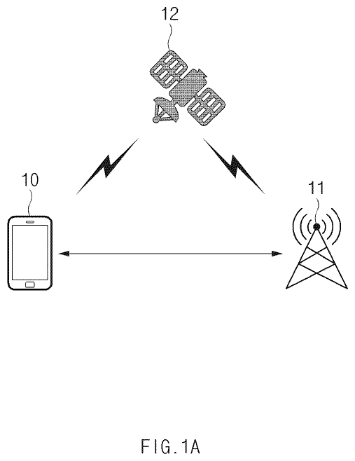

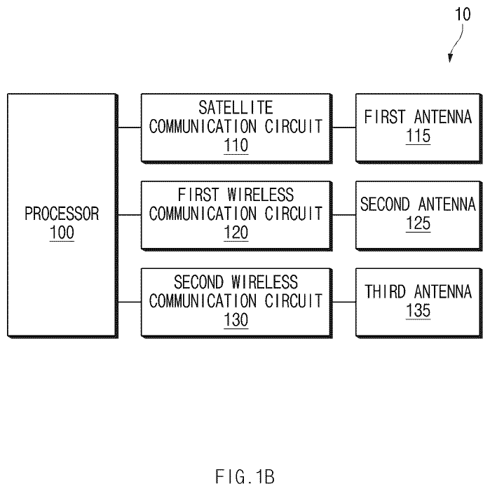

FIG. 1A illustrates a system including an electronic device, a base station, and a satellite according to an embodiment of the disclosure.

Referring to FIG. 1A, an electronic device 10 may perform wireless communication with a base station 11. In one example, the electronic device 10 may transmit and receive signals associated with cellular communication while performing wireless communication with the base station 11. For example, the electronic device 10 may receive information regarding uplink wireless resources allocated to the electronic device 10 from the base station 11 to perform voice call or data communication. In this case, the information regarding wireless resources may include information indicating a first signal associated with cellular communication. For example, the information regarding wireless resources may include information about a center frequency of the first signal, a frequency band, and/or the second harmonic component of the first signal to identify the first signal.

According to an embodiment, an electronic device 10 may transmit and receive satellite signals to and from a satellite 12 through wireless communication with the satellite 12. For example, the electronic device 10 may receive a satellite signal associated with a global navigation satellite system (GNSS) from the satellite 12 to perform a positioning operation using the satellite 12. In one example, the electronic device 10 may receive a satellite signal associated with satellite communication from the satellite 12 to perform long-distance satellite communication with an external electronic device using the satellite 12.

According to an embodiment, the GNSS signal may include an upper L-band (L1) and/or a lower L-band (L5). For example, the upper L-band (L1) may include GPS (L1) with a center frequency of 1575.42 MHz, GLONASS (L1) with a center frequency of 1602 MHz, Beidou (B1) with a center frequency of 1561.098 MHz, and Galileo (E1) with a center frequency of 1575.42 MHz. The lower L band (L5) consists of GPS (L5) and Galileo (E5a) with a center frequency around 1176.45 MHz, and GLONASS (L3) and Beidou (B2) with a center frequency around 1207.14 MHz.

According to an embodiment, the electronic device 10 may simultaneously transmit and receive satellite signals and signals associated with cellular communication. For example, the electronic device 10 may receive a signal associated with satellite communication while transmitting an uplink signal based on cellular communication.

According to an embodiment, the electronic device 10 may additionally utilize third generation (3G), fourth generation (4G), and/or fifth generation (5G) network resources for fast and accurate signal transmission and reception in the operation of transmitting and receiving satellite signals. For example, the electronic device 10 may use a GPS signal to identify an accurate location of a user in order to provide location-based services, and may use a long term evolution (LTE) signal to provide map, weather, route guidance services, and the like based on a user's location.

According to an embodiment, the strength of the GNSS signal may be approximately −130 dBm, which is weaker than other signals. In one example, signals other than the GNSS signal may act as noise to the GNSS signal, and the noise may degrade the signal quality (e.g., a carrier to noise ratio (CN0)) of the GNSS signal, thereby reducing the reception sensitivity of the GNSS signal. This noise may occur to a greater or lesser extent depending on the location of the antenna for transmitting and receiving other signals, the proximity between the frequency band of the other signals and the frequency band of the GNSS signal, a communication duplexing scheme, signal radiation characteristics, or the like. In one example, the signal radiation characteristics may be affected by surrounding metal or a location of a person's body.

According to an embodiment, as signals with various characteristics, such as 5G signals or SOS low-orbit satellite communication signals with a center frequency of 1.6 GHz, are newly developed and LTE frequencies are reused in a 5G environment, terminals may require more antennas. Accordingly, the satellite signals and the cellular signal have no choice but to share a limited antenna of the electronic device 10 or share frequencies through a filter, and in this case, the satellite signal is exposed to more noise, which may result in a reduction in reception sensitivity.

FIG. 1B is a block diagram illustrating a configuration of the electronic device according to an embodiment of the disclosure.

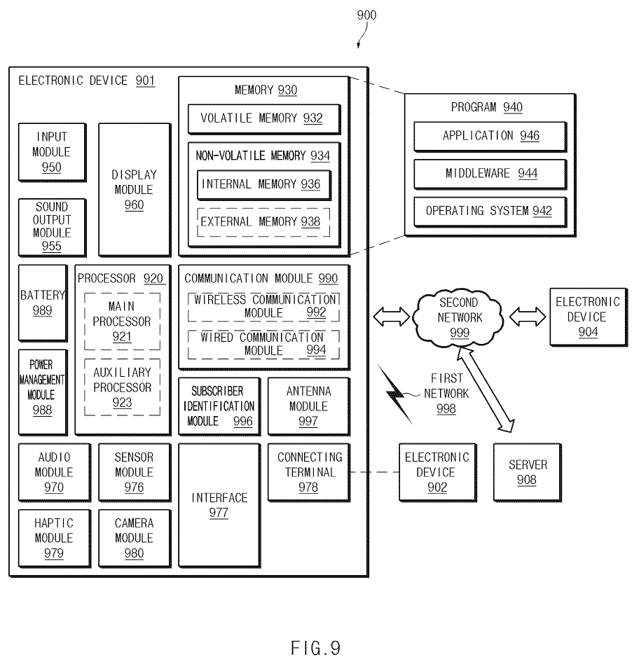

Referring to FIG. 1B, the electronic device 10 may include a processor 100, a satellite communication circuit 110, a first antenna 115, a first wireless communication circuit 120, a second antenna 125, a second wireless communication circuit 130, and a third antenna 135. In one example, the electronic device 10 of FIG. 1B may correspond to an electronic device 901 in FIG. 9. Components of the electronic device 10 described below with reference to FIG. 1B are merely an example, and the embodiments of the disclosure are not limited thereto. In one example, the electronic device 10 may not include at least some of the components illustrated in FIG. 1B. In one example, the electronic device 10 may further include other components (e.g., components of the electronic device 901 in FIG. 9) in addition to the components illustrated in FIG. 1B.

According to an embodiment, the processor 100 may be communicatively (e.g., electrically or operatively) coupled to the satellite communication circuit 110, the first wireless communication circuit 120, and the second wireless communication circuit 130. The satellite communication circuit 110 may be communicatively (e.g., electrically or operatively) coupled to the first antenna 115, the first wireless communication circuit 120 may be electrically or operatively connected to the second antenna 125, and the second wireless communication circuit 130 may be communicatively (e.g., electrically or operatively) coupled to the third antenna 135. “Being operationally connected between components” may mean that the components are functionally connected or communicatively connected. For example, components that are operationally or electrically connected may exchange data with each other. For example, the processor 100 in FIG. 1B may correspond to the processor 920 in FIG. 9.

According to an embodiment, the processor 100 of the electronic device 10 may control various components constituting the electronic device 10. In this case, the processor 100 may correspond to an application processor (AP) and/or communication processor (CP) (e.g., a modem) included within the electronic device 10. The AP and/or CP may be communicatively (e.g., electrically or operatively) coupled to the satellite communication circuit 110, the first wireless communication circuit 120, or the second wireless communication circuit 130 of the electronic device 10. In one example, the processor 100 may utilize the first wireless communication circuit 120, the second antenna 125, the second wireless communication circuit 130, or the third antenna 135 to transmit and receive signals associated with cellular communication. For example, the processor 100 may receive information regarding uplink wireless resources allocated to the electronic device 10 using the first wireless communication circuit 120.

According to an embodiment, the satellite communication circuit 110 of the electronic device 10 may include at least one circuit for transmitting and receiving satellite signals. The satellite communication circuit 110 may include at least one circuit configured to perform signal amplification, signal noise removal, and/or signal conversion. In one example, the satellite communication circuit 110 may receive a satellite signal through the first antenna 115. The satellite communication circuit 110 may process the received signal and transmit the processed signal to the processor 100. The satellite communication circuit 110 may be configured to perform noise removal, amplification, and/or frequency conversion (e.g., down-converting) on the received signal.

According to an embodiment, the electronic device 10 may transmit satellite signals through at least one antenna. At least one satellite communication circuit included in the electronic device 10 may process the signal received from the processor 100 and radiate the processed signal through at least one antenna. At least one satellite communication circuit may be configured to perform noise removal, amplification, and/or frequency conversion (e.g., up-converting) on the signal received from the processor 100.

According to an embodiment, the electronic device 10 may transmit and receive satellite signals using at least one antenna. In one example, at least one satellite communication circuit included in the electronic device 10 may transmit and receive satellite signals using at least one antenna included in the electronic device 10. In one example, the satellite signal transmitted and received by at least one satellite communication circuit included in the electronic device 10 may correspond to a signal for performing non-terrestrial network (NTN) communication or low earth orbit (LEO) communication. For example, the user may perform the LEO communication for transmitting and receiving an SOS signal using at least one satellite communication circuit included in the electronic device 10 even in a situation in which cellular network resources are not available.

According to an embodiment, the first antenna 115 may include at least one radiator. The first antenna 115 may include at least one radiator formed on at least a portion of the housing of the electronic device 10 and/or an internal substrate of the electronic device 10. At least one radiator may be configured to have an electrical length or resonant frequency corresponding to the satellite signal. For example, the satellite communication circuit 110 may receive the satellite signal from the satellite 12 or an external electronic device through the first antenna 115.

According to an embodiment, the satellite communication circuit 110 may receive satellite signals using the first antenna 115. According to an embodiment, the processor 100 may utilize the satellite communication circuit 110 and/or the first antenna 115 to receive satellite signals. For example, the processor 100 may receive a satellite signal corresponding to a GPS signal using the satellite communication circuit 110. According to an embodiment, at least one satellite communication circuit included in the electronic device 10 may transmit and receive a satellite signal by feeding power to at least one antenna included in the electronic device 10. According to an embodiment, the processor 100 may utilize at least one satellite communication circuit included in the electronic device 10 and/or at least one antenna included in the electronic device 10 to transmit and receive a satellite signal. For example, the processor 100 may transmit and receive a signal corresponding to LEO communication using at least one satellite communication circuit included in the electronic device 10. A configuration of the first satellite communication circuit 110, which will be described below, is merely an example, and the embodiments of the disclosure are not limited thereto.

According to an embodiment, the first satellite communication circuit 110 may correspond to a satellite communication circuit that receives a satellite signal. For example, the first satellite communication circuit 110 may correspond to a satellite communication circuit that receives a satellite signal to perform GNSS communication. In one example, the first satellite communication circuit 110 may correspond to a satellite communication circuit that transmits and receives satellite signals. For example, the first satellite communication circuit 110 may correspond to a satellite communication circuit that transmits and receives satellite signals to perform LEO communication and NTN communication. The operation of the first satellite communication circuit 110 of the disclosure is merely an example, and the embodiments of the disclosure are not limited thereto. For example, the description stating that the first satellite communication circuit 110 transmits and receives satellite signals does not limit the first satellite communication circuit 110 to performing GNSS communication. For example, the description stating that the first satellite communication circuit 110 receives a satellite signal does not limit the first satellite communication circuit to performing LEO or NTN communication.

According to an embodiment, the first wireless communication circuit 120 of the electronic device 10 may include at least one circuit for transmitting and receiving a signal associated with cellular communication. The first wireless communication circuit 120 may include at least one circuit configured to perform signal amplification, signal noise removal, and/or signal conversion. In one example, the first wireless communication circuit 120 may receive a signal associated with cellular communication through the second antenna 125. The first wireless communication circuit 120 may process the received signal and transmit the processed signal to the processor 100. The first wireless communication circuit 120 may be configured to perform noise removal, amplification, and/or frequency conversion (e.g., down-converting) on the received signal. In one example, the second wireless communication circuit 130 may also include the same components as those of the first wireless communication circuit 120 described above and may be configured to perform the same operation.

According to an embodiment, the first wireless communication circuit 120 may transmit a signal associated with cellular communication through the second antenna 125. The first wireless communication circuit 120 may process the signal received from the processor 100 and radiate the processed signal through the second antenna 125. The first wireless communication circuit 120 may be configured to perform noise removal, amplification, and/or frequency conversion (e.g., up-converting) on the signal received from the processor 100.

According to an embodiment, the second antenna 125 may include at least one radiator. The second antenna 125 may include at least one radiator formed on at least a portion of the housing of the electronic device 10 and/or the internal substrate of the electronic device 10. At least one radiator may be configured to have an electrical length or resonant frequency corresponding to a signal associated with cellular communication. For example, the first wireless communication circuit 120 may receive a cellular signal from the base station 11 or a peripheral electronic device through the second antenna 125.

According to an embodiment, the first wireless communication circuit 120 may transmit and receive a signal associated with cellular communication by feeding power to the second antenna 125. In one example, the second wireless communication circuit 130 and the third antenna 135 may also include the same components as those of the first wireless communication circuit 120 and the second antenna 125 described above, and may be configured to perform the same operation. In one example, the first wireless communication circuit 120 and the second antenna 125 may be positioned in an upper portion of the electronic device 10, and the second wireless communication circuit 130 and the third antenna 135 may be positioned in a lower portion of the electronic device 10. In one example, the first wireless communication circuit 120 and the second antenna 125 may be positioned closer to the satellite communication circuit 110 and the first antenna 115 than to the second wireless communication circuit 130 and the third antenna 135.

According to an embodiment, a satellite signal receiver (not illustrated) may be included between the processor 100 and the satellite communication circuit 110, and a transceiver (not illustrated) may be included between the processor 100 and the first wireless communication circuit 120 or the second wireless communication circuit 130. The satellite signal receiver (not illustrated) or transceiver (not illustrated) may receive data for controlling signals transmitted and received from the processor 100, generate signals to be transmitted, and process received signals. In one example, the processor 100 may be communicatively (e.g., electrically or operatively) coupled to the transceiver (not illustrated) and the satellite signal receiver (not illustrated) to identify the transmission and reception state of the cellular signal and the reception state of the satellite signal. Meanwhile, it is assumed that the cellular signal of the disclosure may correspond to a wireless communication signal rather than a satellite signal. For example, the first wireless communication circuit 120 and the second wireless communication circuit 130 may transmit and receive a signal associated with wireless fidelity (WiFi) other than the cellular signal. In the disclosure, for convenience of description, examples are described mainly with reference to cellular communication and satellite communication. However, those skilled in the art will appreciate that the embodiments of the disclosure may also be applied to examples involving any other wireless communication and satellite communication examples. For example, embodiments of the disclosure may be applied even when the electronic device 10 transmits and receives signals associated with WiFi, instead of cellular signals. In the disclosure, the reference to transmission and reception of cellular signals may also be used in operations for transmitting and receiving signals associated with Wi-Fi.

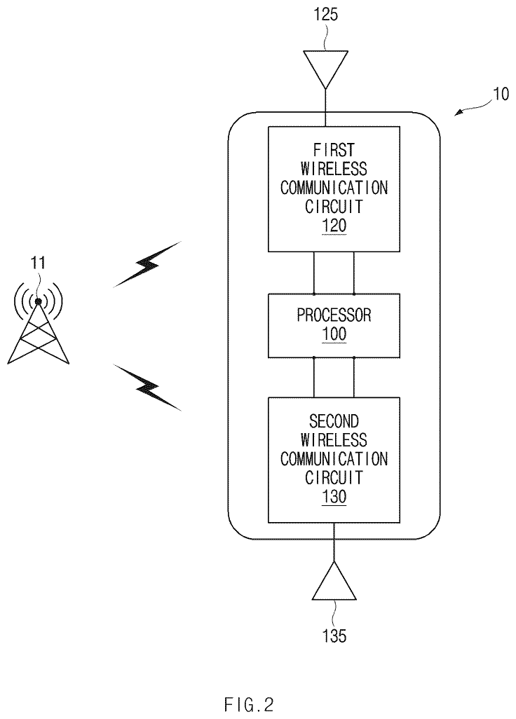

FIG. 2 illustrates a base station transmitting and receiving signals to and from an upper or lower communication circuit of the electronic device according to an embodiment of the disclosure.

Referring to FIG. 2, the electronic device 10 may include a plurality of wireless communication circuits (e.g., 120 and 130). As the electronic device 10 uses one wireless communication circuit to perform wireless communication, a currently used wireless communication circuit may be switched to another wireless communication circuit. In one example, the electronic device 10 may include an increasing number of antennas as it transmits and receives signals of various characteristics to and from any cellular network (e.g., a network including a 3G, 4G, or 5G network), and may change a path of the wireless communication circuit used for wireless communication depending on a situation. For example, a hopping operation may be performed to switch activation states of a plurality of antennas or a plurality of wireless communication circuits.

According to an embodiment, the electronic device 10 may include the first wireless communication circuit 120 positioned in the upper portion of the electronic device 10 and the second wireless communication circuit 130 positioned in the lower portion, and when a user's hand holds the lower portion of the electronic device 10, the signal transmission and reception quality of the second wireless communication circuit 130 and the third antenna 135 may degrade. In this case, the electronic device 10 may perform the hopping operation to activate the first wireless communication circuit 120 in a state in which the second wireless communication circuit 130 is activated. In one example, the electronic device 10 may perform the hopping operation based on the quality of signals transmitted and received by each wireless communication circuit (e.g., 120 or 130). In this case, the electronic device 10 may perform the hopping operation by selecting the wireless communication circuit (e.g., 120 or 130) to be activated based on a result of comparing the quality or strength of the signals transmitted and received by the wireless communication circuit with a preset threshold value. For example, when the signal quality of the signal received from the base station 11 by the first wireless communication circuit 120 is superior to the signal quality of the signal received from the base station 11 by the second wireless communication circuit 130, the electronic device 10 may activate the first wireless communication circuit 120 positioned in the upper portion of the electronic device 10, or in the state in which the second wireless communication circuit 130 is activated, perform the hopping operation to switch the activated wireless communication circuit to the first wireless communication circuit 120.

According to an embodiment, parameter values related to the strength or quality of the signals transmitted and received by the wireless communication circuit (e.g., 120 or 130) or the satellite communication circuit 110 may include reference signal received power (RSRP) or signal electric field strength, and for a satellite signal, maximum transmission and reception power according to an over the air (OTA) test, multi tap junction (MTJ) power, or CN0 may be further included as the parameter values related to the strength or quality of the signal. In one example, the signal strength or quality of the signals transmitted and received by the wireless communication circuit (e.g., 120 or 130) or the satellite communication circuit 110 may be affected by a distance between antennas, frequency proximity between transmitted and received signals, a signal duplexing scheme, or a degree of noise resulting therefrom.

According to an embodiment, when the satellite communication circuit 110 of the electronic device 10 is activated and the first wireless communication circuit 120 positioned adjacent to the satellite communication circuit 110 is activated, the quality of a signal received by the satellite communication circuit 110 may be degraded by the signals transmitted and received by the first wireless communication circuit 120. For example, when only the satellite communication circuit 110 is activated, the noise signal strength may be measured as 3.17156 dB, and the MTJ power corresponding to the interference between signals may not be measured, whereas when the satellite communication circuit 110 and the first wireless communication circuit 120 are activated simultaneously, the noise signal strength may be measured as 3.95772 dB, and the MTJ power corresponding to the interference between signals may be measured as −129.367 dBm.

According to an embodiment, when an electric field strength of a satellite signal received by an activated satellite communication circuit 110 corresponds to a weak electric field and cellular communication is performed using the first wireless communication circuit 120 positioned in the upper portion of electronic device 10, a phenomenon of degradation in positioning accuracy may occur in operations of GPS or the like using the satellite signal due to interference or noise among a plurality of signals. According to an embodiment described below, an electronic device 10 according to an embodiment may improve inter-signal strength adjustment among various signals and inter-signal isolation performance to mitigate factors that degrade signal quality, such as inter-signal interference, noise occurrence, or the like, in an environment in which a wireless communication circuit path varies due to the hopping operation, or in a shared-antenna usage environment in which signals having various characteristics are transmitted and received using a limited number of antennas. In one example, in order to mitigate the factors that degrade signal quality described above, the processor 100 of the electronic device 10 may adjust a maximum transmission power set in the satellite communication circuit or the wireless communication circuit, or perform the hopping operation.

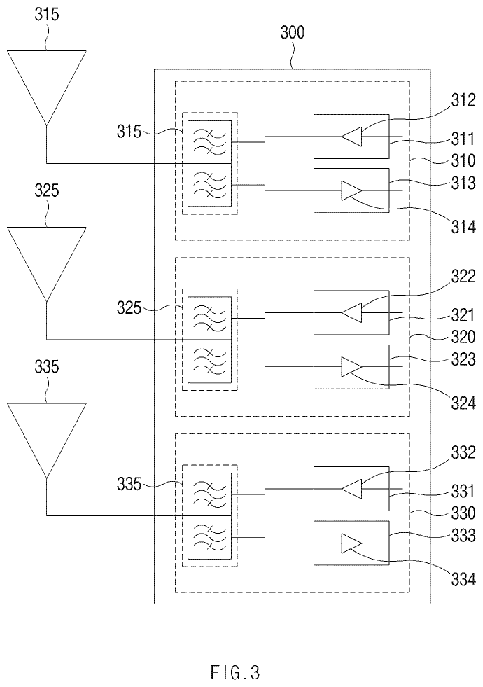

FIG. 3 illustrates a configuration of a wireless communication circuit according to an embodiment of the disclosure.

Referring to FIG. 3, according to an embodiment, a wireless communication circuit 300 may include at least one of a high-band communication circuit 310 configured to transmit and receive signals in a relatively high frequency band, a mid-band communication circuit 320 configured to transmit and receive signals in a relatively middle frequency band, or a low-band communication circuit 330 configured to transmit and receive signals in a relatively low frequency band. For example, the wireless communication circuit 300 may be referred to as a radio frequency front end (RFFE). The wireless communication circuit 300 may be formed as one module (e.g., chip), or may be implemented using a plurality of modules.

According to an embodiment, the high-band communication circuit 310 may be communicatively (e.g., electrically or operatively) coupled to a high-band frequency antenna 315, the mid-band communication circuit 320 may be communicatively (e.g., electrically or operatively) coupled to a mid-band frequency antenna 325, and the low-band communication circuit 330 may be communicatively (e.g., electrically or operatively) coupled to the low-band frequency antenna 335. The high-band communication circuit 310, the mid-band communication circuit 320, or the low-band communication circuit 330 may each include a transmission path (e.g., 311, 321, or 331), a reception path (e.g., 313, 323, or 333), a power amplifier (PA) (e.g., 312, 322, or 332), a low noise amplifier (LNA) (e.g., 314, 324, or 334), or a frequency filter (e.g., 312, 322, or 332), and may further include a matching circuit for matching impedance between circuits and a switch for adjusting a connection state between circuits. In one example, frequency filters (e.g., 312, 322, or 332) may correspond to duplexers that separate the frequency of a transmitter circuit and the frequency of a receiver circuit.

According to an embodiment, each communication circuit (e.g., 310, 320, or 330) may include a transmission path (e.g., 311, 321, or 331), a reception path (e.g., 313, 323, or 333), a power amplifier (PA), and/or an LNA (e.g., 312, 322, or 332). The transmission paths (e.g., 311, 321, and 331) may be included in the respective communication circuits (e.g., 310, 320, and 330) included in the wireless communication circuit 300, allowing voice or data signals generated by the electronic device 10 to be transmitted. In this case, the transmitted signal may be received by another electronic device or the base station. The reception paths (e.g., 313, 323, and 333) may be included in the respective communication circuits (e.g., 310, 320, and 330) included in the wireless communication circuit 300, allowing detection of signals received from the outside. In this case, the received signal may be processed or used by the electronic device 10.

According to an embodiment, the power amplifiers (PA) (e.g., 312, 322, and 332) may amplify signals transmitted through the transmission paths (e.g., 311, 321, and 331), thereby increasing the transmission range of the transmitted signals and improving signal quality. The LNAs (e.g., 312, 322, and 332) may amplify signals received through the reception paths (e.g., 313, 323, and 333), thereby preventing loss of the received signals and improving signal sensitivity, such that reception of a signal from a relatively distant external electronic device (e.g., the base station 11) is enabled. The frequency filters (e.g., 312, 322, and 332) may separate the transmission paths (e.g., 311, 321, and 331) from the reception path (e.g., 313, 323, and 333). For example, the frequency filters (e.g., 312, 322, and 332) may correspond to frequency filters (e.g., duplexers) that separate frequency bands of transmitted signals from frequency bands of received signals. In one example, the frequency filters (e.g., 312, 322, and 332) may attenuate noise components associated with intermodulation (IM) or harmonics that occur as the power amplifiers (PA) (e.g., 312, 322, and 332) or the LNAs (e.g., 312, 322, and 332) amplify the signals.

According to an embodiment, the electronic device 10 may include a plurality of wireless communication circuits (e.g., the wireless communication circuit 300). For example, the plurality of wireless communication circuits may be disposed spaced apart within the electronic device 10. In one example, the electronic device 10 may include a wireless communication circuit positioned in the upper portion of the electronic device 10 and a wireless communication circuit positioned in the lower portion. For example, referring to FIG. 2 together, the first wireless communication circuit 120 and the second wireless communication circuit 130 in FIG. 2 may each include at least some of the components of the wireless communication circuit 300 in FIG. 3. In one example, referring to FIG. 1B together, the first wireless communication circuit 120 in FIG. 1B may be communicatively (e.g., electrically or operatively) coupled to an antenna other than the second antenna 125. In this case, another antenna may be communicatively (e.g., electrically or operatively) coupled to the first wireless communication circuit 120 may correspond to the high-band frequency antenna 315, the mid-band frequency antenna 325, or the low-band frequency antenna 335 in FIG. 3. For example, the second antenna 125 of the first wireless communication circuit 120 may correspond to the high-band frequency antenna 315, and the first wireless communication circuit 120 may be communicatively (e.g., electrically or operatively) coupled to other antennas corresponding to the mid-band frequency antenna 325 or the low-band frequency antenna 335 in addition to the second antenna 125.

The structure of the wireless communication circuit 300 described with reference to FIG. 3 is merely an example, and the embodiments of the disclosure are not limited thereto. For example, the wireless communication circuit 300 may further include at least one component not illustrated in FIG. 3 (e.g., at least one of a filter, a switching circuit, a matching circuit, and/or a power management circuit). For example, the wireless communication circuit 300 may not include at least one of components illustrated in FIG. 3. For example, the number of transmission paths and reception paths illustrated in FIG. 3 is merely an example, and the embodiments of the disclosure are not limited thereto.

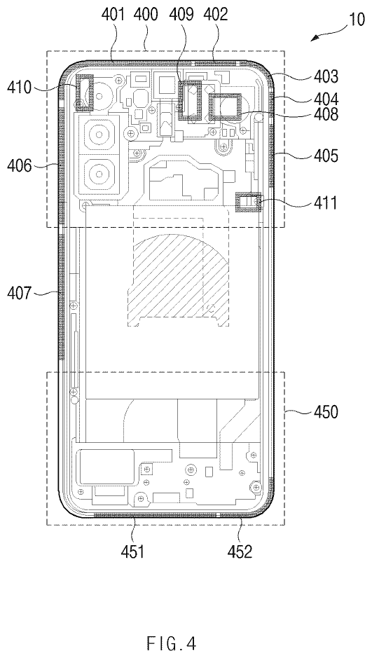

FIG. 4 illustrates positions of antennas included in the electronic device according to an embodiment of the disclosure.

Referring to FIG. 4, the electronic device 10 may include a plurality of antennas, and the plurality of antennas may be positioned at upper, lower, or left and right edges of the electronic device 10 with respect to a rear substrate of the electronic device 10. In one example, the antennas included in the electronic device 10 may be broadly classified into an upper antenna group 400, a lower antenna group 450, and other antennas.

According to an embodiment, the upper antenna group 400 may include antennas positioned at the upper edge of the electronic device 10. The upper antenna group 400 may include a first upper antenna 401, a second upper antenna 402, a third upper antenna 403, a fourth upper antenna 404, a fifth upper antenna 405, a sixth upper antenna 406, an eighth upper antenna 408, a ninth upper antenna 409, a tenth upper antenna 410, and an eleventh upper antenna 411. In one example, referring to FIG. 3 together, the antennas (e.g., 315, 325, and 335) included in the wireless communication circuit 300 may correspond to the first to sixth upper antennas, the seventh antenna, or the eighth to eleventh upper antennas. For example, in one wireless communication circuit 300, the high-band frequency antenna 315 connected to the high-band communication circuit 310 may correspond to the first upper antenna 401, the mid-band frequency antenna 325 connected to the mid-band communication circuit 320 may correspond to the second upper antenna 402, and the low-band frequency antenna 335 connected to the low-band communication circuit 330 may correspond to the fifth upper antenna 405. In one example, the wireless communication circuit 300 may be communicatively (e.g., electrically or operatively) coupled to a plurality of antennas, and the plurality of antennas connected to the wireless communication circuit 300 may correspond to the first upper antenna 401 to the sixth upper antenna 406, a seventh antenna 407, or the eighth upper antenna 408 to the eleventh upper antenna 411, respectively. In one example, segmented parts configured to electrically isolate the antennas may be positioned between each of the antennas. The segmented parts may be formed of a non-conductive material. For example, a segmented part may be disposed between the first upper antenna 401 and the second upper antenna 402 to separate the first upper antenna 401 from the second upper antenna 402, and a segmented part may be disposed between the first upper antenna 401 and the sixth upper antenna 406 to separate the first upper antenna 401 from the sixth upper antenna 406. For example, the fourth upper antenna 404 may be physically separated from the third upper antenna 403 and the fifth upper antenna 405 by the two segment parts.

According to an embodiment, the lower antenna group 450 may include antennas positioned at the lower edge of the electronic device 10. The lower antenna group 450 may include a first lower antenna 451 and a second lower antenna 452. In one example, referring to FIG. 3 together, the antennas (e.g., 315, 325, and 335) included in the wireless communication circuit 300 may correspond to the first lower antenna 451 or the second lower antenna 452. For example, in one wireless communication circuit 300, the high-band frequency antenna 315 connected to the high-band communication circuit 310 may correspond to the first lower antenna 451, and the mid-band frequency antenna 325 connected to the mid-band communication circuit 320 may correspond to the second lower antenna 452. In one example, the wireless communication circuit 300 may be communicatively (e.g., electrically or operatively) coupled to a plurality of antennas, and the plurality of antennas connected to the wireless communication circuit 300 may each correspond to the first lower antenna 451, the second lower antenna 452, or the seventh antenna 407.

In one example, the antennas included in the electronic device 10 may be configured in the form of metal or laser direct structuring (LDS) or in the form of a single modular circuit. For example, the eighth upper antenna 408 to the eleventh upper antenna 411 may correspond to an LDS type and may be positioned inside a circuit board of the electronic device 10.

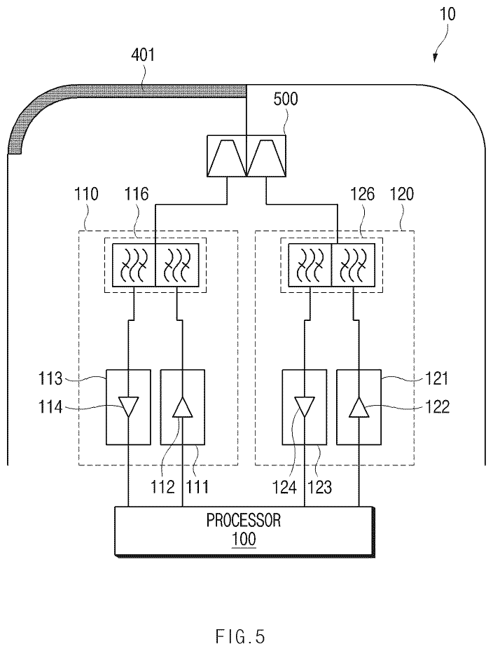

FIG. 5 illustrates a configuration of a shared antenna included in the electronic device according to an embodiment of the disclosure.

Referring to FIG. 5, the satellite communication circuit 110 and the first wireless communication circuit 120 included in the electronic device 10 may be positioned in the upper portion of the electronic device 10 and may use a shared antenna (e.g., the first upper antenna 401). In this case, a frequency filter 500 may be used to separate signals transmitted to and received from the satellite communication circuit 110 from signals transmitted to and received from the first wireless communication circuit 120. The satellite communication circuit 110 and the first wireless communication circuit 120 may each include a transmission path (e.g., 111 or 121), a power amplifier (PA) (e.g., 112 or 122), a reception path (e.g., 113 or 123), an LNA (e.g., 114 or 124), and a frequency filter (e.g., 116 or 126). In one example, the frequency filters (e.g., 116 and 126) included in the satellite communication circuit 110 and the first wireless communication circuit 120 may include a duplexer, and the frequency filter 500 connecting between the satellite communication circuit 110 and the first wireless communication circuit 120 and the shared antenna (e.g., the first upper antenna 401) may include a diplexer. In one example, referring to FIG. 3 together, each of the satellite communication circuit 110 and the first wireless communication circuit 120 may include at least some of the configuration of the wireless communication circuit 300 in FIG. 3. In FIG. 5, for convenience of description, each of the satellite communication circuit 110 and the first wireless communication circuit 120 includes one transmission path and one reception path, but each of the first wireless communication circuit 120 and the second wireless communication circuit 130 may include a plurality of communication circuits (e.g., 310, 320, and 330).

According to an embodiment, the satellite communication circuit 110 may receive a signal of a satellite communication frequency band (e.g., a GNSS, GPS, GLONASS, Beidou, or Galileo signal) using the first upper antenna 401, and the first wireless communication circuit 120 may transmit a cellular signal using the first upper antenna 401. Reception of a satellite communication signal and reception of a cellular signal may be performed substantially simultaneously. For example, the first wireless communication circuit 120 may transmit a cellular signal using the shared antenna (e.g., the second upper antenna 402). The first wireless communication circuit 120 may amplify a signal generated from the processor 100 or the transceiver (not illustrated) using the power amplifier (PA) (e.g., 112 or 122) and transmit the amplified signal to an external electronic device or a base station. In one example, the satellite communication circuit 110 may receive a satellite signal using the shared antenna (e.g., the second upper antenna 402). The satellite communication circuit 110 may receive a signal from an external electronic device, a base station, or a satellite, amplify the received signal using the LNA (e.g., 114 or 124), and transmit the amplified signal to a satellite signal receiver (not illustrated) or the processor 100.

According to an embodiment, the satellite communication circuit 110 may be positioned in the upper portion of the electronic device 10. For example, due to the characteristics of satellite signals having low signal sensitivity, the satellite communication circuit 110 may be mounted on the upper portion of the electronic device 10 to reduce signal sensitivity degradation caused by the grip of a user's hand. In one example, referring to FIG. 4 together, a satellite signal may be received using the first upper antenna 401, the second upper antenna 402, or the third upper antenna 403. The first upper antenna 401, the second upper antenna 402, or the third upper antenna 403 may be used as the shared antenna. In one example, since the number of signals transmitted and received by the electronic device 10 is greater than the number of antennas or communication circuits included in the electronic device 10, signals having different characteristics may be transmitted and received using one shared antenna (e.g., the first upper antenna 401). In this case, interference or noise may occur between signals transmitted and received by the electronic device 10 using the shared antenna (e.g., the first upper antenna 401).

According to an embodiment, when satellite signal sensitivity is degraded, the processor 100 may adjust a threshold transmission power of a cellular signal received using the shared antenna (e.g., the first upper antenna 401), or may receive a cellular signal using the wireless communication circuit (e.g., the second wireless communication circuit 130) positioned in the lower portion of the electronic device 10. For example, when the electronic device 10 receives a GPS signal using the shared antenna (e.g., the first upper antenna 401) and transmits a cellular signal using the shared antenna (e.g., the first upper antenna 401), the processor 100, upon detection of a decrease in the signal quality (e.g., a CN0 level) of the GPS signal, may perform the hopping operation to reduce the threshold transmission power of the cellular signal or to transmit the cellular signal using a wireless communication circuit (e.g., the second wireless communication circuit 130) positioned in the lower portion of the electronic device 10. For example, when the electronic device 10 receives a GPS signal using the shared antenna (e.g., the first upper antenna 401) and transmits a cellular signal using the second wireless communication circuit 130 positioned in the lower portion of the electronic device 10, the processor 100 may, based on the CN0 level of the GPS signal, maintain an operation of transmitting the cellular signal using the second wireless communication circuit 130, or may perform transmission path hoping to transmit the cellular signal using the first wireless communication circuit 120 positioned in the upper portion of the electronic device 10.

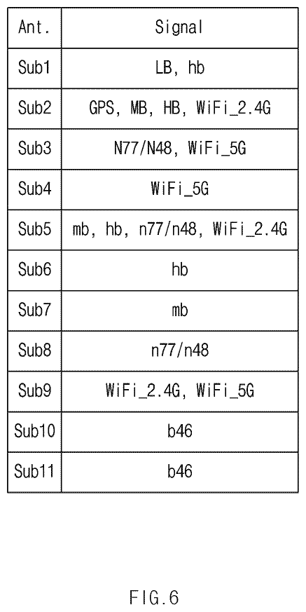

FIG. 6 illustrates signals received by antennas according to an embodiment of the disclosure.

Referring to FIG. 6, the electronic device 10 may transmit and receive signals having various characteristics using antennas included in the electronic device 10 (e.g., the first upper antenna 401 to the eleventh upper antenna 411). In one example, the first upper antenna 401 may transmit and receive a low band (LB) frequency signal or a high-band (HB) frequency signal. In one example, the second upper antenna 402 may transmit and receive a GPS signal, a mid-band (MB) frequency signal, a high-band (HB) frequency signal, or a signal corresponding to WiFi_2.4 GHz (WiFi_2.4G). In one example, the third upper antenna may transmit and receive an NR77 (N77) signal, an NR48 (N48) signal, and a signal corresponding to WiFi_5GHz (WiFi_5G). In one example, the fourth upper antenna 404 may transmit and receive a signal corresponding to WiFi_5GHz (WiFi_5G). In one example, the fifth upper antenna 405 may transmit and receive a mid-band (MB) frequency signal, a high-band (HB) frequency signal, an NR77 (n77) signal, an NR48 (n48) signal, or a signal corresponding to WiFi_2.4 GHz (WiFi_2.4G). In one example, the sixth upper antenna 406 may transmit and receive a high-band (HB) frequency signal. In one example, the seventh antenna 407 may transmit and receive a mid-band (MB) frequency signal. In one example, the eighth upper antenna 408 may transmit and receive an NR77 (n77) signal or an NR48 (n48) signal. In one example, the ninth upper antenna 409 may transmit and receive a signal corresponding to WiFi_2.4 GHz (WiFi_2.4G) or a signal corresponding to WiFi_5 GHz (WiFi_5G). In one example, the tenth upper antenna 410 may transmit and receive a signal corresponding to LTE band 46 (b46). In one example, the eleventh upper antenna 411 may transmit and receive a signal corresponding to LTE band 46 (b46).

According to an embodiment, different antennas may transmit and receive signals having the same characteristics. In one example, the tenth upper antenna 410 and the eleventh upper antenna 411 may transmit and receive a signal corresponding to LTE band 46 (b46). In one example, the fifth upper antenna 405 and the seventh antenna 407 may transmit and receive the mid-band (MB) frequency signal. In one example, the wireless communication circuit included in an electronic device 10 may transmit and receive a millimeter wave (mmWave) signal using at least one antenna. It is assumed that the antennas of the electronic device 10 according to the disclosure transmit and receive signals having various characteristics, as illustrated in FIG. 6. However, the correspondence between a plurality of antennas and signals having various characteristics in FIG. 6 is merely an example, and is not limited to a certain antenna not being capable of transmitting or receiving other signals.

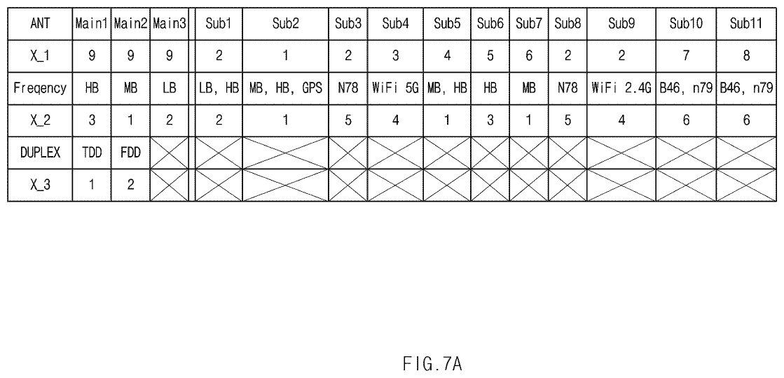

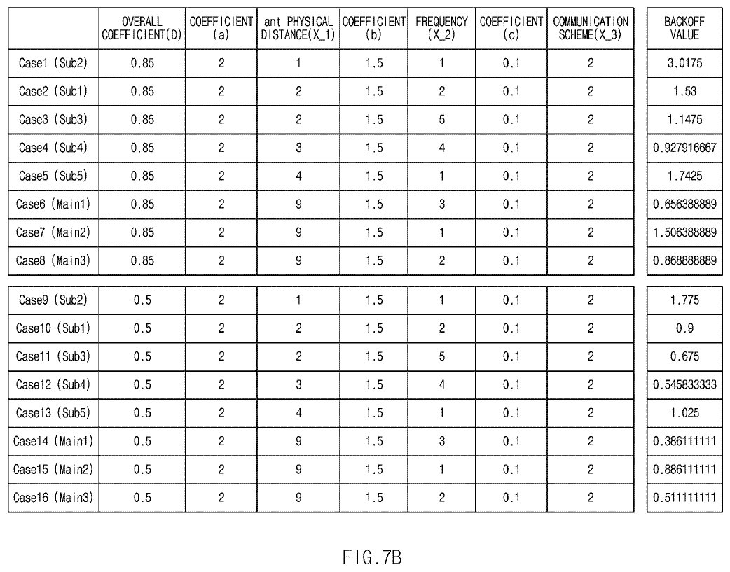

FIG. 7A illustrates an equation and a reference table for calculating backoff values by the electronic device according to an embodiment of the disclosure.

Referring to FIG. 7A, when the electronic device 10 transmits and receives a satellite signal using the satellite communication circuit 110 and transmits and receives a cellular signal using the second wireless communication circuit 130, the processor 100 may control a maximum transmission power corresponding to the cellular signal to mitigate the degradation in sensitivity of the satellite signal due to the cellular signal. In one example, the processor 100 may attenuate the maximum transmission power by subtracting a backoff value from the maximum transmission power corresponding to the cellular signal. In this case, the processor 100 may adjust the backoff value based on a relative distance between activated antennas, a frequency band, or a communication scheme so that the cellular signal quality is not degraded by attenuating the maximum transmission power corresponding to the cellular signal.

According to an embodiment, the processor 100 may set the backoff value to a greater value as the possibility of signal interference between a satellite signal and a cellular signal increases. In one example, the processor 100 may set the backoff value greater as a relative distance between an antenna activated for receiving the satellite signal and an antenna activated for transmitting and receiving the cellular signal is closer, and a frequency band of the satellite signal and a frequency band of the cellular signal are closer. In addition, the processor 100 may set the backoff value to a greater value when the signal duplexing scheme of the electronic device 10 is a time division duplexing (TDD) scheme than when it is a frequency division duplexing (FDD) scheme. In one example, the table of FIG. 7A may be referred to assuming a situation in which the electronic device 10 receives a GPS signal using the second upper antenna 402 in an operation of receiving a satellite signal, and the disclosure will be described based on the table shown in FIG. 7A. However, the equation and table of FIG. 7A are merely an example, and the reference values of the equation and table may be set differently depending on the type of the electronic device 10.

According to an embodiment, in one example, the backoff value may be calculated using the formula D(a(1/X_1)+b(1/X_2)+c(1/X_3)). The formula for calculating the backoff value of the disclosure is merely an example and may be changed based on the type of the electronic device 10 or the communication service state. For example, when the second upper antenna 402 is used as the shared antenna to transmit and receive a satellite signal and a cellular signal, and a satellite signal corresponding to a GPS frequency band and a cellular signal corresponding to a mid-band (MB) frequency signal are transmitted and received, and the TDD-based signal duplexing scheme is adopted, since X_1 is set to 1, X_2 is set to 1, and X_3 is set to 1, the processor 100 may determine the backoff value according to a calculated value of D(a+b+c). In this case, D, a, b, and c included in the formula may be preset as weight values by the processor 100. In one example, when the first upper antenna 401 is used to transmit and receive a cellular signal, a cellular signal corresponding to a low-band (LB) frequency signal is transmitted and received, and the TDD-based signal duplexing scheme is adopted, since X_1 is set to 2, X_2 is set to 2, and X_3 is set to 1, the processor 100 may determine the backoff value according to a calculated value of D(a/2+b/2+c). In one example, when the eleventh upper antenna 411 is used to transmit and receive a cellular signal, a cellular signal corresponding to an NR78 (N78) signal is transmitted and received, and the FDD-based signal duplexing scheme is adopted, since X_1 is set to 8, X_2 is set to 5, and X_3 is set to 2, the processor 100 may determine the backoff value according to a calculated value of D(a/8+b/5+c/2). In one example, when the first lower antenna 451 is used to transmit and receive a cellular signal, a signal corresponding to a WiFi_5 GHz (WiFi_5G) is transmitted and received, and the FDD-based signal duplexing scheme is adopted, since X_1 is set to 9, X_2 is set to 4, and X_3 is set to 2, the processor 100 may determine the backoff value according to a calculated value of D(a/9+b/4+c/2).

According to an embodiment, the processor 100 may subtract the backoff value from the maximum transmission power required for cellular communication to mitigate degradation in signal quality of a satellite signal during an operation of receiving the satellite signal. In this case, the processor 100 may maintain or change the wireless communication circuit used to perform cellular communication by comparing a value obtained by subtracting the backoff value from the maximum transmission power with a threshold transmission power value. The threshold transmission power may correspond to a power value required for smooth operation of cellular communication using the wireless communication circuit positioned in the upper portion of the electronic device 10. In one example, the threshold transmission power may be calculated or preset in the electronic device 10 depending on the type of the electronic device 10 and an electric field of the cellular signal.

According to an embodiment, when the value obtained by subtracting the backoff value from the maximum transmission power is greater than the threshold transmission power value, since the processor 100 may recognize that degradation in signal quality of a satellite signal and a cellular signal is not significant even when the upper wireless communication circuit is used, and thus may activate the upper wireless communication circuit and perform cellular communication. In one example, when the value obtained by subtracting the backoff value from the maximum transmission power is less than the threshold transmission power value, since the processor 100 may recognize that degradation in signal quality of the satellite signal and the cellular signal increases when the upper wireless communication circuit is used, and thus may activate the lower wireless communication circuit and perform cellular communication.

According to an embodiment, when the processor 100 performs cellular communication using the lower wireless communication circuit and the value obtained by subtracting the backoff value from the maximum transmission power is greater than the threshold transmission power value, since the processor 100 may recognize that degradation in signal quality of the satellite signal and the cellular signal is not significant even when the upper wireless communication circuit is used, the processor 100 may perform the hopping operation for using the upper wireless communication circuit from the lower wireless communication circuit to perform cellular communication. In one example, when the value obtained by subtracting the backoff value from the maximum transmission power is less than the threshold transmission power value, since the processor 100 may recognize that degradation in signal quality of the satellite signal and the cellular signal increases when the upper wireless communication circuit is used, and thus may maintain an activation state of the lower wireless communication circuit and perform cellular communication.

The processor 100 of the electronic device 10 according to an embodiment may identify the backoff value set based on the reception strength of satellite communication, compare the backoff value with the threshold transmission power associated with the first wireless communication circuit 120, and select one of the first wireless communication circuit 120 and the second wireless communication circuit 130 based on a result of the comparison.

FIG. 7B illustrates backoff values calculated according to an embodiment of the disclosure.

Referring to FIG. 7B, in the operation of transmitting and receiving a satellite signal and a cellular signal, the processor 100 of the electronic device 10 may calculate a backoff value based on a distance (X_1) between antennas used for transmitting and receiving a satellite signal and a cellular signal, a proximity (X_2) between frequencies of the satellite signal and the cellular signal, and a communication duplexing scheme (X_3) of the electronic device 10. In this case, the processor may adjust an overall coefficient (D) based on an electric field strength of the satellite signal, and may adjust a weight a for X_1, a weight b for X_2, and a weight c for X_3 depending on the type of the electronic device 10. In one example, an electric field of the satellite signal may be identified based on a CN0 value. For example, the CN0 value may be calculated based on satellite signal strengths of top four satellites transmitting the strongest signals among satellites used for satellite signal reception, and the processor 100 may classify a satellite signal received by the electronic device 10 as a weak electric field when the CN0 value corresponding to the satellite signals of the top four satellites is less than 24 dB, as a medium electric field when the CN0 value is greater than or equal to 24 dB and less than 37 dB, and as a strong electric field when the CN0 value is greater than or equal to 37 dB. In one example, the processor 100 may set the overall coefficient (D) to 0.85 when the satellite signal is the weak electric field, set the overall coefficient (D) to 0.5 when the satellite signal is the medium electric field, and set the overall coefficient (D) to 0 when the satellite signal is the strong electric field.

According to an embodiment, when the electric field strength of the satellite signal is weak, the cellular signal corresponding to the mid-band (MB) frequency signal is transmitted and received based on the FDD scheme using the second upper antenna 402, the weight a for X_1 is set to 2, the weight b for X_2 is set to 1.5, and the weight c for X_3 is set to 0.1 (Case 1), the processor 100 may determine the backoff value as a value of 3.0175 according to a calculated value of 0.85 (2/1+1.5/1+0.1/2). In one example, when the electric field strength of the satellite signal is weak, the cellular signal corresponding to the high-band (HB) frequency signal is transmitted and received based on the FDD scheme using the first lower antenna 451, the weight a for X_1 is set to 2, the weight b for X_2 is set to 1.5, and the weight c for X_3 is set to 0.1 (Case 6), the processor 100 may determine the backoff value as a value of approximately 0.6564 according to a calculated value of 0.85 (2/9+1.5/3+0.1/2).

According to an embodiment, when the electric field strength of the satellite signal is medium, the cellular signal corresponding to the low-band (LB) frequency signal is transmitted and received based on the FDD scheme using the first upper antenna 401, the weight a for X_1 is set to 2, the weight b for X_2 is set to 1.5, and the weight c for X_3 is set to 0.1 (Case 10), the processor 100 may determine the backoff value as a value of approximately 0.9 according to a calculated value of 0.5 (2/2+1.5/2+0.1/2). In one example, when the electric field strength of the satellite signal is medium, a signal corresponding to WiFi_5GHz (WiFi_5G) is transmitted and received based on the FDD scheme using the fourth upper antenna 404, the weight a for X_1 is set to 2, the weight b for X_2 is set to 1.5, and the weight c for X_3 is set to 0.1 (Case 12), the processor 100 may determine the backoff value as a value of approximately 0.5458 according to a calculated value of 0.5 (2/3+1.5/4+0.1/2). In one example, when the electric field strength of the satellite signal is medium, the cellular signal corresponding to NR79 (N79) is transmitted and received based on the TDD scheme using the fifth upper antenna 405, the weight a for X_1 is set to 1, the weight b for X_2 is set to 2, and the weight c for X_3 is set to 3 (not illustrated), the processor 100 may determine the backoff value as a value of approximately 1.7917 according to a calculated value of 0.5 (2/3+1.5/4+0.1/2).

According to an embodiment, when the electric field strength of the satellite signal is strong, the processor 100 may not additionally control the maximum transmission power of the cellular signal since the satellite signal sensitivity is sufficiently strong and the resulting sensitivity degradation effect of the satellite signal due to the cellular signal is relatively insignificant. In one example, the processor 100 may determine the backoff value as approximately 0 since the value of the overall coefficient (D) may be set to 0 when the electric field strength of the satellite signal is strong.

According to an embodiment, the processor 100 may adjust data on at least one of the overall coefficient (D), the distance (X_1) between antennas, the weight a for X_1, the proximity (X_2) between frequencies of satellite signals and cellular signals, the weight b for X_2, the communication duplexing scheme (X_3) of the electronic device 10, or the weight c for X_3 in accordance with characteristics of the electronic device 10. In one example, the memory of the electronic device 10 may store the data on at least one of the overall coefficient (D), the distance (X_1) between antennas, the weight a for X_1, the proximity (X_2) between frequencies of satellite signals and cellular signals, the weight b for X_2, the communication duplexing scheme (X_3) of the electronic device 10, or the weight c for X_3.

The processor 100 of the electronic device 10 according to an embodiment may reduce the backoff value as the reception strength of satellite communication increases.

The processor 100 of the electronic device 10 according to an embodiment may perform cellular communication using the second wireless communication circuit 130 when the value obtained by subtracting the backoff value from the maximum transmission power set for the first wireless communication circuit 120 is less than the threshold transmission power.

The processor 100 of the electronic device 10 according to an embodiment may reduce the backoff value as the distance between the first antenna 115 and the second antenna 125 increases.

The processor 100 of the electronic device 10 according to an embodiment may identify the backoff value based on at least one of a first frequency band of a signal associated with cellular communication or a duplexing scheme of cellular communication.

The processor 100 of the electronic device 10 according to an embodiment may increase the backoff value as a proximity between a second frequency band associated with satellite communication and the first frequency band or a proximity between the second frequency band and a harmonic component of the first frequency band increases.

The duplexing scheme according to an embodiment includes a TDD scheme or an FDD scheme, and the processor 100 may identify a greater backoff value for the TDD scheme than for the FDD scheme.

The processor 100 of the electronic device 10 according to an embodiment may perform cellular communication using the first wireless communication circuit 120 when the value obtained by subtracting the backoff value from the maximum transmission power set for the first wireless communication circuit 120 is greater than or equal to the threshold transmission power.

The processor 100 of the electronic device 10 according to an embodiment may set the value obtained by subtracting the backoff value from the maximum transmission power set for the first wireless communication circuit 120 as the maximum transmission power for the first wireless communication circuit 120.

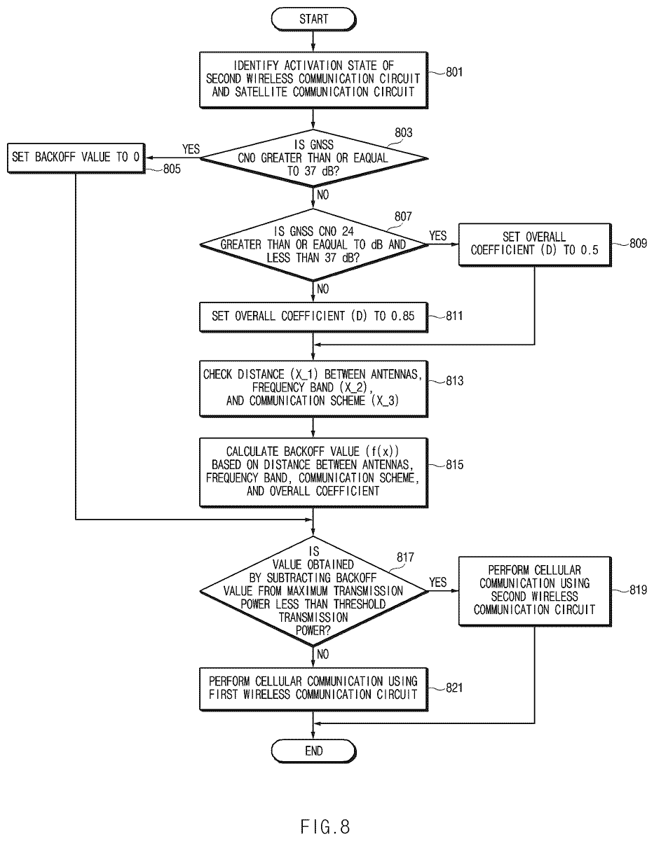

FIG. 8 is a flowchart showing operations of the electronic device according to an embodiment of the disclosure.

Referring to FIG. 8, the processor 100 of the electronic device 10 may check an activation state of the second wireless communication circuit 130 and the satellite communication circuit 110, identify an electric field strength of a satellite signal received using the satellite communication circuit 110, and calculate a backoff value for controlling a maximum transmission power of a cellular signal transmitted and received by the second wireless communication circuit 130 based on at least one parameter value among the electronic field strength of the identified satellite signal, an antenna distance, a frequency band, or a communication scheme. In this case, the processor 100 may compare the backoff value calculated from the maximum transmission power corresponding to the cellular signal with a threshold transmission power of the cellular signal and determine whether to maintain the activation state of the second wireless communication circuit or to perform the hopping operation to activate the first wireless communication circuit. In one example, signals to which the processor 100 applies the backoff value may include a WiFi signal in addition to the cellular signal.

According to an embodiment, the processor 100 may check an activation state of the satellite communication circuit 110, identify an electric field strength of the satellite signal received using the satellite communication circuit 110, and calculate the backoff value for controlling the maximum transmission power of the cellular signal based on at least one parameter value among the electronic field strength of the identified satellite signal, an antenna distance, a frequency band, or a communication scheme. In this case, the processor 100 may compare the backoff value calculated from the maximum transmission power corresponding to the cellular signal with the threshold transmission power of the cellular signal and determine whether to activate the second wireless communication circuit or to activate the first wireless communication circuit.

According to an embodiment, the processor 100 may check an activation state of the satellite communication circuit 110, identify the electric field strength of the satellite signal received using the satellite communication circuit 110, and calculate the backoff value for controlling a maximum transmission power of the cellular signal based on the identified electronic field strength of the satellite signal. In this case, the processor 100 may compare the backoff value calculated from the maximum transmission power corresponding to the cellular signal with the threshold transmission power of the cellular signal and determine whether to activate the second wireless communication circuit or to activate the first wireless communication circuit.

According to an embodiment, the processor 100 may identify the activation state of the second wireless communication circuit 130 and the satellite communication circuit 110 in operation 801. In one example, the processor 100 may check a state in which a satellite signal is received while a cellular signal is transmitted and received through the second wireless communication circuit 130 positioned in the lower portion of the electronic device 10. For example, a user may run a map application to perform a positioning operation based on GPS signals, while simultaneously running a phone application to perform cellular communication, and in this case, the processor 100 may check the activation state of the second wireless communication circuit 130 and the satellite communication circuit 110. In one example, the processor 100 may determine whether to perform a hopping operation that switches the activation state from the second wireless communication circuit 130 to the first wireless communication circuit 120 in relation to the transmission and reception operation of the cellular signal.

According to an embodiment, in operation 803, the processor 100 may identify signal quality or signal strength of the satellite signal that is being received. In one example, the processor 100 may identify the quality or signal strength of the satellite signal based on a CN0 value of the satellite signal. For example, the processor 100 may identify a CN0 value of the GNSS signal received using the satellite communication circuit 110, and determine that the greater the CN0 value, the stronger the quality or signal strength of the GNSS signal. For example, the processor 100 may determine that the electric field of the GNSS signal corresponds to a strong electric field when the CN0 value of the GNSS signal received using the satellite communication circuit 110 is greater than or equal to 37 dB.

According to an embodiment, when the CN0 value of the satellite signal is greater than or equal to 37 dB (e.g., YES in operation 803), in operation 805, the processor 100 may set the backoff value to 0. In one example, when the CN0 value of the satellite signal being received is greater than or equal to 37 dB, the processor 100 may determine that even when the cellular signal is received together, the degradation effect in signal quality of the satellite signal due to the cellular signal is not significant and set the backoff value for controlling the maximum transmission power of the cellular signal to 0 or a relatively small value. For example, the processor 100 may set the backoff value of the cellular signal to a relatively small value when an MTJ power of the GPS signal is less than a preset threshold value or is not measured.

According to an embodiment, in operation 807, the processor 100 may identify the signal quality or signal strength of the satellite signal being received when the CN 0 value of the satellite signal is less than 37 dB (e.g., NO in operation 803). In one example, the processor 100 may identify the quality or signal strength of the satellite signal based on the CN0 value of the satellite signal. For example, the processor 100 may identify a CN0 value of the GPS signal received using the satellite communication circuit 110, and determine that the greater the CN0 value, the stronger the quality or signal strength of the GNSS signal. For example, the processor 100 may determine that the electric field of the GPS signal corresponds to a medium electric field when the CN0 value of the GPS signal received using the satellite communication circuit 110 is greater than or equal to 24 dB and less than 37 dB.

According to an embodiment, in operation 809, the processor 100 may set the overall coefficient (D) to 0.5 when the CN0 value of the satellite signal is greater than or equal to 24 dB and less than 37 dB (e.g., YES in operation 807). In one example, when the CN0 value of the satellite signal being received is greater than or equal to 24 dB and less than 37 dB, the processor 100 may determine that the degradation effect in signal quality of the satellite signal due to the cellular signal corresponds to an intermediate level and set the overall coefficient (D) of the backoff value for controlling the maximum transmission power of the cellular signal to 0.5 or a relatively intermediate value. For example, when it is determined that the MTJ power of the GPS signal corresponds to a medium level of strength, the processor 100 may set the backoff value of the cellular signal to a relatively intermediate value.

According to an embodiment, when the CN0 value of the satellite signal is less than 24 dB (e.g., NO in operation 807), in operation 811, the processor 100 may set the overall coefficient (D) to 0.85. In one example, when the CN0 value of the satellite signal being received is less than 24 dB, the processor 100 may determine that the degradation effect in signal quality of the satellite signal due to the cellular signal is significant and set the overall coefficient (D) of the backoff value for controlling the maximum transmission power of the cellular signal to 0.85 or a relatively large value. For example, when it is determined that the MTJ power of the GPS signal is relatively strong, the processor 100 may set the backoff value of the cellular signal to a relatively large value.

According to an embodiment, in operation 813, the processor 100 may identify the distance (X_1) between antennas, the proximity (X_2) between frequencies of satellite signals and cellular signals, and the communication duplexing scheme (X_3) of the electronic device 10. In one example, the processor 100 may set an X_1 value to a smaller value as the distance between an antenna used to receive a satellite signal and an antenna used to receive a cellular signal becomes closer. For example, referring to FIG. 7A together, when a satellite signal is received using the second upper antenna 402 and a cellular signal is also received using the second upper antenna 402, since the second upper antenna 402 is used as the shared antenna and has the greatest proximity, the processor 100 may set the X_1 value to 1, which is the relatively smallest value.

According to an embodiment, the processor 100 may set an X_2 value to a smaller value as the proximity (X_2) between frequencies of the satellite signal and the cellular signal increases. For example, referring to FIG. 7A together, when the satellite signal corresponds to a GPS L1 frequency band (e.g., intermediate frequency: 1575.42 MHz) and the cellular signal corresponds to a mid-band (MB) frequency (e.g., intermediate frequency: 1500 MHz), since the frequency band of the satellite signal and the frequency band of the cellular signal may be adjacent to each other or include a common frequency band and thus the proximity is relatively the greatest, the processor 100 may set the X_2 value to 1, which is the relatively smallest value.

According to an embodiment, the processor 100 may set an X_3 value to a small value when the communication duplexing scheme (X_3) of the electronic device 10 is the TDD scheme, and may set the X_3 value to a large value when the communication duplexing scheme (X_3) of the electronic device 10 is the FDD scheme. For example, referring to FIG. 7A together, when the duplexing scheme of cellular communication corresponds to the TDD scheme, the processor 100 may set the X_3 value to 1, which is the relatively smallest value, since the TDD scheme may have a greater interference effect between signals than the FDD scheme.

According to an embodiment, the processor 100 may set a corresponding parameter value (e.g., X_4) to a smaller value as the proximity between a frequency of a second harmonic component of the satellite signal and the frequency of the cellular signal increases. For example, since the frequency band of the satellite signal corresponds to 1574.42 MHz to 1576.42 MHz, which is the GPS L1 frequency band, and the frequency band of the second harmonic component of the cellular signal corresponds to 1554 MHz to 1574 MHz, which is the frequency band of the second harmonic component of the LTE band 13, and thus the frequency band of the satellite signal and the frequency band of the second harmonic component of the cellular signal may include frequency bands adjacent to each other and thus the proximity is relatively large, the processor 100 may set the corresponding parameter value (e.g., X_4) to 1, which is a relatively small value.

In one example, the distance (X_1) between antennas, the proximity (X_2) between frequencies of the satellite signal and the cellular signal, and the communication duplexing scheme (X_3) of the electronic device 10 may correspond to parameter values for determining a degree of interference or noise between signals. In one example, it may be understood that, as a possibility that interference or noise occurs increases with the distance (X_1) between antennas, or as a possibility that interference or noise occurs increases with the proximity (X_2) between frequencies of the satellite signal and the cellular signal, the signal sensitivity degradation effect due to interference or noise between signals becomes greater. In addition, it may be understood that the communication duplexing scheme (X_3) has a greater signal sensitivity degradation effect due to interference or noise between signals in the FDD scheme than in the TDD scheme.

According to an embodiment, the distance (X_1) between antennas may correspond to a parameter corresponding to a degree of interference isolation between antennas rather than a physical distance between antennas positioned in the electronic device 10. For example, the distance between the second upper antenna 402 and the third upper antenna 403 is closer than the distance between the second upper antenna 402 and the tenth upper antenna 410, but when an internal circuit design and a shielding material or the like of the electronic device 10 are positioned between the second upper antenna 402 and the third upper antenna 403, the X_1 value according to the distance between the second upper antenna 402 and the third upper antenna 403 may have a value greater than the X_1 value according to the distance between the second upper antenna 402 and the tenth upper antenna 410. In one example, the proximity (X_2) between frequencies of the satellite signal and the cellular signal may correspond to a parameter corresponding to the degree of possibility of occurrence of interference between frequencies, rather than a numerical proximity between the actual frequency bands of the signals received by the electronic device 10. For example, the proximity between the mid-band (MB) frequency and the GPS frequency band may be recognized as being numerically greater than the proximity between the high-band (HB) frequency and the GPS frequency band, but when a signal corresponding to the mid-band (MB) frequency is tuned or the strength of the signal is attenuated in the electronic device 10, the X_2 value according to the proximity between the mid-band (MB) frequency and the GPS frequency band may have a greater value than the X_2 value according to the proximity between the high-band (HB) frequency and the GPS frequency band.

According to an embodiment, the processor 100 may calculate the backoff value by applying the parameter values corresponding to the distance (X_1) between antennas, the proximity (X_2) between frequencies of the satellite signal and the cellular signal, and the communication duplexing scheme (X_3) of the electronic device 10, the set overall coefficient (D) value, and set weighting coefficients (a, b, c) to the backoff value calculation formula D(a/X_1+b/X_2+c/X_3) in operation 815. For example, referring to FIG. 7A together, when it is assumed that the electronic device 10 receives a medium-electric field satellite signal using the second upper antenna 402, and the processor 100 may adopt the FDD scheme and may identify D as 0.5, identify the X_1 value as 7, identify the X_2 value as 5, and identify the X_3 value as 2 when a cellular signal corresponding to an NR78 (N78) signal is transmitted and received using the tenth upper antenna 410. In this case, when the weight a for X_1 is set to 2, the weight b for X_2 to 1.5, and the weight c for X_3 to 0.1, the processor 100 may calculate the backoff value to be a value of approximately 0.3179.

According to an embodiment, in operation 817, the processor 100 may compare a value obtained by subtracting the backoff value from the maximum transmission power set for the cellular signal with a threshold transmission power value required to perform cellular communication using the upper wireless communication circuit. In one example, the processor 100 may set the value obtained by subtracting the backoff value from the maximum transmission power as a new maximum transmission power corresponding to the cellular signal, and compare the new maximum transmission power with the threshold transmission power value for performing cellular communication using the upper wireless communication circuit. The threshold transmission power may correspond to a transmission power value required for the upper wireless communication circuit to use the upper wireless communication circuit. In one example, the threshold transmission power may be calculated by an internal algorithm of the processor 100 based on the type of the electronic device 10 or an internal circuit layout.

According to an embodiment, in operation 819, the processor 100 may perform cellular communication using the second wireless communication circuit 130 when the value obtained by subtracting the backoff value from the maximum transmission power corresponding to the cellular signal is less than the threshold transmission power (e.g., YES in operation 817). In one example, when the value obtained by subtracting the backoff value from the maximum transmission power corresponding to the cellular signal is less than the threshold transmission power, the processor 100 may determine that cellular communication using the first wireless communication circuit 120 corresponding to the upper communication circuit is not suitable, and may be configured to perform cellular communication using the second wireless communication circuit 130. For example, when the processor 100 receives the satellite signal using the satellite communication circuit 110 and simultaneously performs cellular communication using the second wireless communication circuit 130 corresponding to the lower communication circuit, the processor 100 may maintain the activation state of the second wireless communication circuit 130 when the value obtained by subtracting the backoff value from the maximum transmission power corresponding to the cellular signal is less than the threshold transmission power. In one example, when the processor 100 receives a satellite signal using the satellite communication circuit 110 and simultaneously performs cellular communication using the first wireless communication circuit 120 corresponding to the upper communication circuit, the processor 100 may activate the second wireless communication circuit 130 by performing the hopping operation and perform cellular communication using the second wireless communication circuit 130 when the value obtained by subtracting the backoff value from the maximum transmission power corresponding to the cellular signal is less than the threshold transmission power.

According to an embodiment, in operation 821, the processor 100 may perform cellular communication using the first wireless communication circuit 120 when the value obtained by subtracting the backoff value from the maximum transmission power corresponding to the cellular signal is greater than or equal to the threshold transmission power (e.g., NO in operation 817). In one example, when the value obtained by subtracting the backoff value from the maximum transmission power corresponding to the cellular signal is greater than or equal to the threshold transmission power, the processor 100 may determine that cellular communication using the first wireless communication circuit 120 corresponding to the upper communication circuit is suitable, and may be configured to perform cellular communication using the first wireless communication circuit 120. For example, when the processor 100 receives a satellite signal using the satellite communication circuit 110 and simultaneously performs cellular communication using the second wireless communication circuit 130 corresponding to the lower communication circuit, the processor 100 may activate the first wireless communication circuit 120 by performing the hopping operation and perform cellular communication using the first wireless communication circuit 120 when the value obtained by subtracting the backoff value from the maximum transmission power corresponding to the cellular signal is greater than or equal to the threshold transmission power. In one example, when the processor 100 receives the satellite signal using the satellite communication circuit 110 and simultaneously performs cellular communication using the first wireless communication circuit 120 corresponding to the lower communication circuit, the processor 100 may maintain the activation state of the first wireless communication circuit 120 when the value obtained by subtracting the backoff value from the maximum transmission power corresponding to the cellular signal is greater than or equal to the threshold transmission power.

According to an embodiment, the processor 100 may calculate the backoff value based on each of the distance (X_1) between antennas, the proximity (X_2) between frequencies of satellite signals and cellular signals, or the communication duplexing scheme (X_3) of the electronic device 10. In one example, the processor 100 may calculate the backoff value based on the distance (X_1) between the antennas. In one example, the processor 100 may calculate the backoff value based on the proximity (X_2) between frequencies of the satellite signal and the cellular signal. In one example, the processor 100 may calculate the backoff value based on the communication duplexing scheme (X_3) of the electronic device 10.

FIG. 9 is a block diagram illustrating an electronic device 901 in a network environment 900 according to an embodiment of the disclosure.

Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to one embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to one embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first antenna;
a second antenna;
a third antenna spaced relatively farther apart from the first antenna than the second antenna;
a satellite communication circuit communicatively coupled to the first antenna and configured to transmit and receive a satellite signal;
a first wireless communication circuit communicatively coupled to the second antenna and configured to transmit and receive a signal associated with cellular communication;
a second wireless communication circuit communicatively coupled to the third antenna and configured to transmit and receive a signal associated with cellular communication;
at least one processor communicatively coupled to the satellite communication circuit, the first wireless communication circuit, and the second wireless communication circuit and including a processing circuit; and
memory communicatively coupled to the at least one processor, the memory storing instructions that, when executed by the at least one processor individually or collectively, cause the electronic device to:
identify activation of satellite communication using the satellite communication circuit during cellular communication using the second wireless communication circuit, and
perform, based on the identification of the activation of the satellite communication, the cellular communication using one of the first wireless communication circuit and the second wireless communication circuit based on a reception strength of the satellite communication and a threshold transmission power associated with the first wireless communication circuit.

2. The electronic device of claim 1, wherein the instructions, when executed by the at least one processor individually or collectively, cause the electronic device to:
identify a backoff value set based on the reception strength of the satellite communication,
compare the backoff value with a threshold transmission power associated with the first wireless communication circuit, and
select one of the first wireless communication circuit and the second wireless communication circuit based on the comparison.

3. The electronic device of claim 2, wherein the instructions, when executed by the at least one processor individually or collectively, cause the electronic device to:
decrease the backoff value as the reception strength of the satellite communication increases.

4. The electronic device of claim 2, wherein the instructions, when executed by the at least one processor individually or collectively, cause the electronic device to:
perform the cellular communication using the second wireless communication circuit when a value obtained by subtracting the backoff value from a maximum transmission power set for the first wireless communication circuit is less than the threshold transmission power.

5. The electronic device of claim 4, wherein the instructions, when executed by the at least one processor individually or collectively, cause the electronic device to:
decrease the backoff value as a distance between the first antenna and the second antenna increases.

6. The electronic device of claim 5, wherein the instructions, when executed by the at least one processor individually or collectively, cause the electronic device to:
identify the backoff value based on at least one of a first frequency band of a signal associated with the cellular communication or a duplexing scheme of the cellular communication.

7. The electronic device of claim 6, wherein the instructions, when executed by the at least one processor individually or collectively, cause the electronic device to:
increase the backoff value as a proximity between a second frequency band associated with the satellite communication and the first frequency band or a proximity between the second frequency band and a harmonic component of the first frequency band increases.

8. The electronic device of claim 6,
wherein the duplexing scheme includes a time division duplexing (TDD) scheme or a frequency division duplexing (FDD) scheme, and
wherein the instructions, when executed by the at least one processor individually or collectively, cause the electronic device to:
identify a greater backoff value for the TDD scheme than for the FDD scheme.

9. The electronic device of claim 4, wherein the instructions, when executed by the at least one processor individually or collectively, cause the electronic device to:
perform the cellular communication using the first wireless communication circuit when the value obtained by subtracting the backoff value from the maximum transmission power set for the first wireless communication circuit is greater than or equal to the threshold transmission power.

10. The electronic device of claim 9, wherein the instructions, when executed by the at least one processor individually or collectively, cause the electronic device to:
set the value obtained by subtracting the backoff value from the maximum transmission power set for the first wireless communication circuit as a maximum transmission power for the first wireless communication circuit.

11. A method of performing wireless communication by an electronic device, the method comprising:
identifying activation of satellite communication using a satellite communication circuit of the electronic device during cellular communication using a second wireless communication circuit of the electronic device; and
performing, based on the identifying of the activation of the satellite communication, the cellular communication using one of a first wireless communication circuit of the electronic device and the second wireless communication circuit based on a reception strength of the satellite communication and a threshold transmission power associated with the first wireless communication circuit.

12. The method of claim 11, further comprising:
identifying a backoff value set based on the reception strength of the satellite communication;
comparing the backoff value with a threshold transmission power associated with the first wireless communication circuit; and
selecting one of the first wireless communication circuit and the second wireless communication circuit based on the comparison.

13. The method of claim 12, further comprising:
decreasing the backoff value as the reception strength of the satellite communication increases.

14. The method of claim 12, further comprising:
performing the cellular communication using the second wireless communication circuit when a value obtained by subtracting the backoff value from a maximum transmission power set for the first wireless communication circuit is less than the threshold transmission power.

15. The method of claim 14, further comprising:
performing the cellular communication using the first wireless communication circuit when the value obtained by subtracting the backoff value from the maximum transmission power set for the first wireless communication circuit is greater than or equal to the threshold transmission power.

16. The method of claim 15, further comprising:
setting the value obtained by subtracting the backoff value from the maximum transmission power set for the first wireless communication circuit as a maximum transmission power for the first wireless communication circuit.

17. The method of claim 14, further comprising:
decreasing the backoff value as a distance between a first antenna communicatively coupled to the satellite communication circuit and a second antenna communicatively coupled to the first wireless communication circuit increases.

18. The method of claim 17, further comprising:
identifying the backoff value based on at least one of a first frequency band of a signal associated with the cellular communication or a duplexing scheme of the cellular communication.

19. The method of claim 18, further comprising:
increasing the backoff value as a proximity between a second frequency band associated with the satellite communication and the first frequency band or a proximity between the second frequency band and a harmonic component of the first frequency band increases.

20. The method of claim 18,
wherein the duplexing scheme includes a time division duplexing (TDD) scheme or a frequency division duplexing (FDD) scheme, and
wherein the identifying of the backoff value based on at least one of the first frequency band of the signal associated with the cellular communication or the duplexing scheme of the cellular communication includes identifying a greater backoff value for the TDD scheme than for the FDD scheme.
